(19) United States
(12) Patent Application Publication
(10) Pub. No.: US 2009/0099286 A1
(43) Pub. Date: Apr. 16, 2009

(54) Highly heat-resistant stabilizer bar bush rubber composition

(75) Inventor: Jong Min Park, Incheon (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/006,389

(22) Filed: Dec. 31, 2007

(30) Foreign Application Priority Data
Oct. 15, 2007 (KR) 10-2007-0103679

(51) Int. Cl. C08L 23/16; C08L 9/00; C08K 5/098; C08K 5/09; C08K 5/17

(52) U.S. Cl. 524/186; 524/502; 524/525; 524/399; 524/322

(57) ABSTRACT

The present invention relates to a stabilizer bar bush rubber composition comprising an ethylene-propylene rubber, a peroxide crosslinking agent, a crosslinking promoter, an activator, an antiaging agent, a filler. The present invention provides a stabilizer bar bush with improved heat resistance and lubricant blooming at high temperature by adjusting polymer composition of the rubber composition, crosslinking density, kind and content of activator and filler, for example.

### CROSS-REFERENCE TO RELATED APPLICATION

This application claims under 35 U.S.C. § 119(a) the benefit of Korean Patent Application No. 10-2007-0103679 filed on Oct. 15, 2007, the entire contents of which are incorporated herein by reference.

### TECHNICAL FIELD

The present invention relates to a rubber composition for a stabilizer bar of a vehicle, which comprises an ethylene-propylene rubber, a peroxide crosslinking agent, a crosslinking promoter, an activator, an antiaging agent, a filler and which the stabilizer bar with improved heat resistance at high temperature and improved lubricant blooming at high temperature.

### BACKGROUND ART

A stabilizer bar is provided with an automobile to prevent the body of the automobile from slanting while the automobile turns into a corner. The stabilizer is provided with a stabilizer bar bush which is a rubber material supporting the stabilizer bar. The stabilizer bar bush is required to have durability against strong force exerted from outside and desired NVH (noise, vibration and harshness) performance, thereby providing a comfort ride.

There have been a lot of researches on the aging property of a stabilizer bar bush around 70 to 80° C., but few on the property at high temperature (around 120° C.). As a result, in spite of the continued improvement of the aging property of a stabilizer bar bush, the rubber often becomes defective or broken under elevated engine room temperature, thereby negatively affecting the quality of the automobile.

In order to solve the problem of the rubber deterioration/breakage, the base polymer has been replaced from natural rubber (NR) or natural rubber/butadiene rubber (NR/BR) to EPDM rubber, which is a synthetic rubber.

### SUMMARY OF THE DISCLOSURE

The present inventors accomplished the present invention by changing the polymer blended in the material of a stabilizer bar bush in order to improve heat resistance, selecting peroxide crosslinking agent which offers superior heat resistance and favorable compression set, and adding a predetermined amount of amide in order to maintain self lubrication.

Accordingly, an object of the present invention is to provide a stabilizer bar rubber composition capable of maintaining the elasticity of rubber material even at high temperature, thereby minimizing compression set of the stabilizer bar bush and maintaining initial comfort ride regardless of the change of engine room temperature, exhaust gas temperature, and seasons.

In one aspect, the present invention provides a stabilizer bar bush rubber composition comprising an ethylene-propylene rubber, a peroxide crosslinking agent, a crosslinking promoter, an activator, an antiaging agent, a filler and a lubricant, wherein the stabilizer bush rubber composition comprises, per 100 parts by weight of the ethylene-propylene rubber, 4 to 8 parts by weight of the peroxide crosslinking agent, 0.5 to 5 parts by weight of the crosslinking promoter, which improves crosslinking efficiency, 1 to 10 parts by weight of the activator, 1 to 5 parts by weight of the antiaging agent, 40 to 60 parts by weight of carbon black as the filler, and 4 to 16 parts by weight of the lubricant.

Particularly, through the adjustment of polymer composition, selection of appropriate crosslinking system and crosslinking density, and control of filler content, high-temperature performance of rubber could be improved outstandingly.

Further, the rubber retains elasticity due to the improved high-temperature performance, maintains initial comfort ride, and is applicable to even the high temperature of engine.

### DETAILED DESCRIPTION

The highly heat-resistant stabilizer bar bush rubber composition of the present invention comprises an ethylene-propylene rubber, a peroxide crosslinking agent, a crosslinking promoter, an activator, an antiaging agent, a filler and a lubricant. Preferably, it comprises, per 100 parts by weight of the ethylene-propylene rubber, 4 to 8 parts by weight of the peroxide crosslinking agent, 0.5 to 5 parts by weight of the crosslinking promoter, which improves crosslinking efficiency, 1 to 10 parts by weight of the activator, 1 to 5 parts by weight of the antiaging agent, 40 to 60 parts by weight of carbon black as the filler, and 4 to 16 parts by weight of the lubricant.

The rubber component ethylene-propylene rubber has superior heat resistance, cold resistance and ozone resistance. Especially, the proportion of ethylene and propylene can be varied as required, depending on the wanted property. In the present invention, the ethylene is preferably included in an amount of 45 to 55 weight % based on the total weight of the ethylene-propylene rubber in order to attain superior high-temperature performance and low compression set. It may also be used at high temperature after curing with a peroxide crosslinking agent. And, by increasing the content of ethylene, the operability of rubber can be improved, and the content of oil which improves self lubrication can be increased.

In the present invention, the crosslinking promoter is preferably used in 0.5 to 5 parts by weight per 100 parts by weight of the ethylene propylene rubber. When the crosslinking promoter is used in less than 0.5 part by weight, a sufficient curing cannot be attained because an effective crosslinking system is not obtained. And, when the crosslinking promoter is used in excess of 5 parts by weight, scorch may occur during the operation.

The crosslinking promoter may be any one commonly used to improve crosslinking efficiency in the manufacture of anti-vibration rubber, without limitation. For example, one or more selected from the group of TMPTMA (1,1,1-trimethylolpropane trimethacrylate), TAC (triallyl cyanurate), TAIC [triallyl-1,3,5-triazine-2,4,6-(1H,3H, 5H)-trione], EGDMA (ethylene glycol dimethacrylate), BGDMA (1,3-butylene glycol dimethacrylate), ZDA (Saret modified metallic diacrylate), DAP (diammonium phosphate) and LPBD (1,2-polybutadiene polymer dispersed on synthetic calcium silicate) may be used.

Preferably, the proportion of such a crosslinking promoter to a peroxide crosslinking agent to be described below is in the range from 1.3:1 to 2.5:1. When the content of the promoter is below 1.3, crosslinking density may decrease. In contrast, when it exceeds 2.5, heat resistance may decrease.

The peroxide crosslinking agent greatly affects the crosslinking, together with the crosslinking promoter, and preferably is used in 4 to 8 parts by weight, per 100 parts by weight of the ethylene propylene rubber.

When the peroxide crosslinking agent is used in less than 4 parts by weight, it is very difficult to obtain an effective crosslinking system. And, when it exceeds 8 parts by weight, an unwanted material property may be derived.

The most preferable example of the peroxide crosslinking agent is di-(2-t-butylperoxyisopropyl)benzene (F-40).

The activator activates the crosslinking promoter, and may be any one commonly used in the manufacture of anti-vibration rubber, without limitation. Available examples include stearic acid, zinc stearate, and so forth. In the present invention, the activator is used in 1 to 10 parts by weight per 100 parts by weight of the ethylene-propylene rubber. When the activator is used in less than 1 part by weight, crosslinking proceeds slowly. And, when the activator is used in excess of 10 parts by weight, crosslinking proceeds too quickly, resulting in productivity problem.

For the antiaging agent, a reaction product of diphenylamine and acetone at high temperature, for example, BLE-65 (N-phenyl-N′-isopropyl-p-phenylenediamine, may be used in 1 to 5 parts by weight to prevent oxidation. In addition, a highly heat-resistant phenyl based antiaging agent RD (polymerized 2,2,4-trimethyl-1,2 dihydroquinoline) may be used in 1 to 5 parts by weight.

The lubricant reduces friction of rubber, and, thereby reduces noise generation. For the lubricant, a micro paraffin wax or a amide based lubricant is normally used. As the amide based lubricant, oleamide and erucamide, which have different molecular weights, are used. They control the time required for surface blooming, and reduces the friction of rubber in the long term. In the present invention, micro paraffin wax is used in 1 to 5 parts by weight, and the amide based lubricant is used in 3 to 11 parts by weight. When the content of the lubricants is below the aforesaid range, friction does not decrease as required. And, when too much lubricant is used, operability, compression set and elasticity may be deteriorated.

The composition of the present invention further comprises 40 to 60 parts by weight of carbon black as the filler to improve reinforcing property and wear resistance. For example, it is preferable to use a mixture of Corax N300 (Korea Carbon Black) and Corax N762 (Korea Carbon Black).

In order that the present invention may be further understood, the following examples are set forth. However, these examples are for purposes of illustration only and are not to be construed as limiting the scope of the present invention in any manner.

### EXAMPLES 1-2 AND COMPARATIVE EXAMPLES 1-4

In order to prepare a highly heat-resistant stabilizer bar bush rubber composition, a sample was prepared according to the composition presented in Table 1. An ethylene propylene (EPDM) rubber was masticated for 2 minutes using a Banbury mixer (Kobe Steel, Co.), and mixed with carbon black, stearic acid, zinc oxide, an antiaging agent, a peroxide crosslinking agent and a crosslinking promoter. A final master batch (FMB) was prepared after 3 minutes' of mixing.

Thus obtained FMB was dispersively mixed using a roll mixer. The resultant rubber composition was tested for optimum curing time using a flow meter (Monsanto R100). A sample was attained by applying a pressure of 210 kgf/cm² at 170° C. using a compressor (Toyo Seiki Co. Ltd.).

TABLE 1

| | | Parts by weight | | | | | |
|---|---|---|---|---|---|---|---|
| | | Comparative Examples | | | | Examples | |
| | Composition | 1 | 2 | 3 | 4 | 1 | 2 |
| Rubber | EPDM | 100 | 100 | 100 | — | 100 | 100 |
| | NR | — | — | — | 100 | — | — |
| Activator | Zinc stearate | 3 | 3 | 3 | 3 | 3 | 3 |
| | Stearic acid | 3 | 3 | 3 | 3 | 3 | 3 |
| Antiaging | RD | 2 | 2 | 2 | 2 | 1.5 | 2 |
| agent | BLE-65 | 1 | 1 | 1 | 1 | 1.5 | 1 |
| Filler | N330 | 60 | 40 | 40 | 30 | 50 | 40 |
| | N762 | — | 20 | 20 | 30 | 10 | 20 |
| Peroxide | F-40 | 6 | 3 | 9 | 3 | 4 | 6 |
| crosslinking | | | | | | | |
| agent | | | | | | | |
| Crosslinking | TAC | 1 | 1 | 1 | 1.5 | 1.5 | 1 |
| promoter | TAIC | 2 | 2 | 2 | 2 | 1.5 | 2 |
| Lubricant | Micro | 3 | 3 | 3 | 3 | 3 | 3 |
| | paraffin wax | | | | | | |
| | Amide based | 7 | 7 | 7 | 7 | 7 | 7 |
| | lubricant | | | | | | |

EPDM: ethylene-propylene rubber comprising 50-55 weight % of ethylene
NR: SMR CV 60
ZnO: Hanil, 99.5%
RD: polymerized 2,2,4-trimethyl-1,2 dihydroquinoline, Kumho, Rubatan 184-RD
BLE-65: N-phenyl-N′-isopropyl-p-phenylenediamine
N330: Korea Carbon Black, Corax N330
N762: Korea Carbon Black, Corax N762
F-40: di-(2-t-butylperoxyisopropyl)benzene
TAC: triallyl cyanurate
TAIC: trially-1,3,5-triazine-2,4,6-(1H,3H,5H)-trione

### TEST EXAMPLE

The rubber samples prepared in Examples 1-2 and Comparative Examples 1-4 were tested as follows. The result is presented in Table 2.

Hardness of stabilizer bar bush rubber was measured according to KS M 6784.

Tensile strength, elongation and modulus of stabilizer bar bush rubber were measured according to KS M 6782.

Antiaging property of stabilizer bar bush rubber was observed after keeping at 120° C. for 70 hours.

TABLE 2

| | Comparative Examples | | | | Examples | |
|---|---|---|---|---|---|---|
| | 1 | 2 | 3 | 4 | 1 | 2 |
| Hardness (Shore A) | 68 | 64 | 72 | 71 | 69 | 70 |
| Polymer composition | 53.9 | 53.9 | 53.9 | 53.9 | 53.9 | 53.9 |
| (wt %) | | | | | | |
| Antiaging agent | 2.5 | 2.5 | 2.5 | 2.5 | 1.5 | 1.5 |
| Tensile strength | 135 | 130 | 140 | 134 | 144 | 146 |
| Post-aging tensile | 143 | 140 | 147 | 142 | 154 | 157 |
| strength (heat | | | | | | |
| resistance) | | | | | | |
| High-temperature | 7.5 | 6.5 | 7.3 | 8.2 | 5.7 | 6.1 |
| compression set (%) | | | | | | |
| 120° C., 22 hr | | | | | | |
| Low-temperature | 32 | 34.3 | 38.0 | 39.1 | 24.6 | 25.1 |
| compression set (%) | | | | | | |
| −30° C., 72 hr | | | | | | |

As can be seen in Table 2, Examples 1 and 2, wherein carbon blacks N330 and N762 were used together, exhibited better tensile strength and compression set than Comparative Example 1, wherein only one carbon black N330 was used as the filler.

Further, Examples 1 and 2, wherein the peroxide crosslinking agent and the crosslinking promoter were used within a range from 1.3:1 to 2.5:1, exhibited better mechanical properties including tensile strength than Comparative Examples 2 and 3, wherein the proportion of the peroxide crosslinking agent to the crosslinking promoter was outside the range. And, Comparative Example 4, wherein the composition of the natural rubber (NR) and the filler were changed, exhibited worse properties including heat resistance than Examples 1 and 2.

It will be understood that the embodiments described herein are exemplary, and that those skilled in the art may make various variations and modifications without departing from the spirit and scope of the present invention. All such variations and modifications are intended to be included within the spirit and scope of the invention.

1. A highly heat-resistant stabilizer bar bush rubber composition comprising an ethylene-propylene rubber, a peroxide crosslinking agent, a crosslinking promoter, an activator, an antiaging agent, a filler and a lubricant, wherein the composition comprises, per 100 parts by weight of the ethylene-propylene rubber, 4 to 8 parts of the peroxide crosslinking agent, 0.5 to 5 parts by weight of the crosslinking promoter, 1 to 10 parts by weight of the activator, 1 to 5 parts by weight of the antiaging agent, 40 to 60 parts by weight of the filler and 4 to 16 parts by weight of the lubricant.

2. The highly heat-resistant stabilizer bar bush rubber composition as claimed in claim 1, wherein the ethylene-propylene rubber comprises 45 to 55 weight % of ethylene based on the total weight of the rubber.

3. The highly heat-resistant stabilizer bar bush rubber composition as claimed in claim 1, wherein the ratio of the peroxide crosslinking agent to the crosslinking promoter ranges from 1.3:1 to 2.5:1.

4. The highly heat-resistant stabilizer bar bush rubber composition as claimed in claim 1, wherein the crosslinking promoter is at least one selected from the group consisting of TMPTMA (1,1,1-trimethylolpropane trimethacrylate), TAC (triallyl cyanurate), TAIC [triallyl-1,3,5-triazine-2,4,6-(1H,3H,5H)-trione], EGDMA (ethylene glycol dimethacrylate), BGDMA (1,3-butylene glycol dimethacrylate), ZDA (Saret modified metallic diacrylate), DAP (diammonium phosphate) and LPBD (1,2-polybutadiene polymer dispersed on synthetic calcium silicate).

5. The highly heat-resistant stabilizer bar bush rubber composition as claimed in claim 1, wherein the peroxide crosslinking agent is di-(2-t-butylperoxyisopropyl)benzene (F-40).

6. The highly heat-resistant stabilizer bar bush rubber composition as claimed in claim 1, wherein the activator is stearic acid or zinc stearate.

7. The highly heat-resistant stabilizer bar bush rubber composition as claimed in claim 1, wherein the antiaging agent is N-phenyl-N′-isopropyl-p-phenylenediamine, which is a reaction product of diphenylamine and acetone, or polymerized 2,2,4-trimethyl-1,2 dihydroquinoline.

8. The highly heat-resistant stabilizer bar bush rubber composition as claimed in claim 1, wherein the lubricant is a mixture of 1 to 5 parts by weight of micro paraffin wax and 3 to 11 parts by weight of an amide based lubricant.
